(19) United States
(12) Patent Application Publication
(10) Pub. No.: US 2011/0320813 A1
(43) Pub. Date: Dec. 29, 2011

(54) Network system and authentication method thereof

(76) Inventors: Junko Suginaka, Tokyo (JP); Yoshihisa Furukawa, Tokyo (JP)

(21) Appl. No.: 13/138,442

(22) PCT Filed: Mar. 10, 2009
(86) PCT No.: PCT/JP2009/054487

§ 371 Date: Aug. 16, 2011

(51) Int. Cl. H04L 9/32; G06F 15/16

(52) U.S. Cl. 713/168

(57) ABSTRACT

A management server includes an encryption processor for individually scrambling a control program and authentication information in response to a transmission request from a terminal, a merging unit for merging the control program and the authentication information subsequent to scrambling, a communication control unit for transmitting the merge information to the terminal, and a permission signal generator for checking decrypted authentication information from the terminal against the original authentication information, and generating a permission signal that permits the control program to be installed if the decrypted authentication signal matches the original authentication signal. The terminal includes a communication control unit for transmitting the transmission request to the management server, a decryption processor unit for separating the control program and the authentication information from the merge signal from the management server, and individually decrypting the control program and the authentication information, the communication control unit for returning the decrypted authentication information to the management server, and an installation processor unit for starting installing the control program in response to a reception of the permission signal from the management server.

### TECHNICAL FIELD

The present invention relates to a network system, and an authentication method thereof for transmitting via a network a control program stored on a management server to a terminal having placed a transmission request and installing the control program on the terminal.

### BACKGROUND ART

Identity fraud is currently on the rise in the network field. Someone uses the identity of another person, hacks into a server, a database, or the like using the identity, and steals or tampers with data there.

Patent Document 1 describes one apparatus. In response to a first access from a terminal, the apparatus assigns a unique authentication key to the terminal and transmits the unique authentication key to the terminal for storage on the terminal. The apparatus registers in a management table the authentication key with terminal identification information mapped thereto. The apparatus and the terminal identify each other using the authentication key thereafter. The apparatus performs digitally a true/false determination on the terminal and identifies the terminal without the need to implement any particular element, such as a semiconductor chip, having digital certificate data written thereon, and thus prevents identity fraud.

Patent Document 2 describes one system. First identification information is temporarily granted when a connection to a network is permitted, and second identification information is used for authentication to get the permission of the use of services. A correspondence relation between the first identification information and the second identification information is checked using third identification information. The system thus reduces an unlawful use of services based on identity fraud even in a network, such as the Internet, where addresses of senders are variable.

[Patent Document 1]

Japanese Unexamined Patent Application Publication No. 2008-271069

[Patent Document 2]

Japanese Unexamined Patent Application Publication No. 2006-113624

### DISCLOSURE OF INVENTION

### Problems to be Solved by the Invention

The apparatus described in Patent Document 1 operates on the premise that the apparatus assigns the authentication key to the terminal at the first access of the terminal to the apparatus. The apparatus is thus prevented from performing a false determination that may be caused by the terminal-side which tampers with or deletes the authentication key. The apparatus described in Patent Document 2 is provided with an authentication server and an application server, and needs to authenticate the terminal using the first through third identification information. As a result, a authentication process and management of the information become complex.

The object of the invention is to provide a network system and an authentication method of the network system for preventing identity fraud. A control program and authentication information attached thereto are individually scrambled before being transmitted to a terminal as a transmission destination. The authentication information decrypted at the terminal as the transmission destination is received by a management server, and is then matched against original authentication information. The network system thus authenticates at least the terminal as the transmission destination, and prevents identity fraud.

### Means for Solving the Problems

A network system of the invention transmits via a network a control program stored on a management server to a terminal having transmitted a transmission request of the control program and installs the control program onto the terminal. The management server includes encryption unit for individually scrambling the control program and authentication information attached to the control program in response to a reception of the transmission request from the terminal, merging unit for generating merge information by merging the control program and the authentication information subsequent to scrambling, server-side transmission unit for transmitting the merge information merged by the merging unit to the terminal, and permission signal generation unit for checking decrypted authentication information returned from the terminal against the original authentication information, and generating a permission signal permitting the control signal to be installed on the terminal and transmitting the permission signal to the terminal if the decrypted authentication information matches the original authentication information. The terminal includes terminal-side transmission unit for transmitting the transmission request to the management server, decryption unit for separating the control program and the authentication information from the merge information received from the management server and individually decrypting the control information and the authentication information, returning unit for returning the decrypted authentication information to the management server, and installation processor unit for starting installing the control program in response to a reception of the permission signal from the management server.

An authentication method is related to a network system of the invention for transmitting via a network a control program stored on a management server to a terminal having transmitted a transmission request of the control program and installing the control program onto the terminal. The authentication method includes a step of terminal-side transmission of the terminal for transmitting the transmission request to the management server, a step of encryption of the management server for individually scrambling the control program and authentication information attached to the control program in response to a reception of the transmission request from the terminal, a step of merging of the management server for generating merge information by merging the control program and the authentication information subsequent to the scrambling, a step of server-side transmission of the management server for transmitting the merge information merged by the step of merging to the terminal, a step of decryption of the terminal for separating the control program and the authentication information from the merge information received from the management server and individually decrypting the control information and the authentication information, a step of returning of the terminal for returning the decrypted authentication information to the management server, a step of permission signal generation of the management server for checking the decrypted authentication information returned from the terminal against the original authentication information, and generating a permission signal permitting the control signal to be installed on the terminal and transmitting the permission signal to the terminal if the decrypted authentication information matches the original authentication information, and a step of installation processor of the terminal for starting installing the control program in response to a reception of the permission signal from the management server.

According to the invention, the management server individually scrambles the control program and the authentication information, merges the scrambled program and authentication information, and then transmits the merge information to the terminal. The terminal separates the control program and the authentication information from the merge information, and then decrypts at least the authentication information. The terminal returns the decrypted authentication information to the management server. The management server checks the decrypted authentication information against the original authentication information. The management server generates the permission signal to permit installation of the control signal and then transmits the permission signal to the terminal if the decrypted authentication information matches the original authentication information. Upon receiving the permission signal, the terminal starts installing the control signal. The management server thus authenticates an appropriate terminal, and prevents identity fraud as much as possible. The management server thus prevents an apparatus having a false identity from inputting an unwanted or an unscrupulous program (software program for tampering with, deleting, and stealing an internal file).

### Advantages

According to the invention, the management server operates in cooperation with the terminal over the network, and at least authenticates the terminal and prevents identity fraud.

### BRIEF DESCRIPTION OF THE DRAWINGS

FIG. 1 generally illustrates a configuration of a network system of the invention.

FIG. 2 is a function block diagram of a member terminal 1.

FIG. 3 is a functional block diagram of a management server 3.

FIG. 4A illustrate the principle of an encryption process performed using a geometric structure with n being 3, showing information units into which a control program as an encryption target is segmented. FIG. 4B illustrate the principle of an encryption process performed using a geometric structure with n being 3, showing a relationship between the information units and addresses of cubes Cu forming the geometric structure.

FIG. 5 illustrates a rotation of the geometric structure about each axis.

FIG. 6 illustrates shift characteristics of the addresses of the cubes Cu that shift in response to the rotation of the geometric structure.

FIG. 7A illustrates shift characteristics of the addresses that shift in response to the rotation of the cube in another embodiment, showing shift characteristics with n being 5. FIG. 7B illustrates shift characteristics of the addresses that shift in response to the rotation of the cube in another embodiment, showing shift characteristics with n being 6.

FIG. 8 illustrates an image that presents in an easy-to-see fashion a relationship between a geometric structure 7 for a control program and a geometric structure 70 for authentication information.

FIG. 9A illustrates information units into which the authentication information is segmented. FIG. 9B illustrates a relationship between each information unit and an address of each cube Cu′ forming the geometric structure.

FIG. 10 illustrates the control program and the authentication information in a merged state.

FIG. 11 is a flowchart of a startup process executed by a controller 30 in the management server 3.

FIG. 12 is a flowchart of the startup process executed by the controller 30 in the management server 3.

FIG. 13 is a flowchart of a startup process executed by a controller 100 in the terminal 1.

FIG. 14 is a flowchart of the startup process executed by the controller 100 in the terminal 1.

### EXPLANATION OF REFERENCE NUMBERS

1 Member terminal (terminal)
2 Banking institution terminal (terminal)
3 Management institution server
6 Dedicated network
7, 70 Geometric structure (virtual geometric structure)
10 Modem (terminal)
100 Controller
101 Communication control unit (terminal-side transmission unit, returning unit)
102 Startup processor unit
103 Decryption processor unit (decryption unit)
104 Installation processor unit (installation processor unit)
105 Image display control unit
106 File production processor unit
107 Uninstallation processor unit
110 Storage
111 File storage unit
112 Screen image storage unit
113 Startup program storage unit
114 Control program storage unit
15 Main switch
30 Controller
301 Communication control unit (server-side transmission unit)
302 Encryption processor (encryption unit)
3021 Address conversion unit (first and second address conversion unit)
3022 Information segmentation unit (segmentation unit)
3023 Scrambling unit (first and second scrambling unit)
3024 Size adjusting unit
3025 Key information attaching unit
303 Merging unit (merging unit)
304 Authenticator
305 Permission signal generator (permission signal generation unit)
306 Information processor
31 Storage
311 Member information storage unit
312 Communication file storage unit
313 Encryption program storage unit
314 Control program storage unit
A, B, and C Rotation axes (center axes)
D Control program
D1-D27 Information units of the control program
E Authentication information
E1-E27 Information units of the authentication information
Cu1-Cu27, Cu1′-Cu27′ Cubes

### BEST MODE FOR CARRYING OUT THE INVENTION

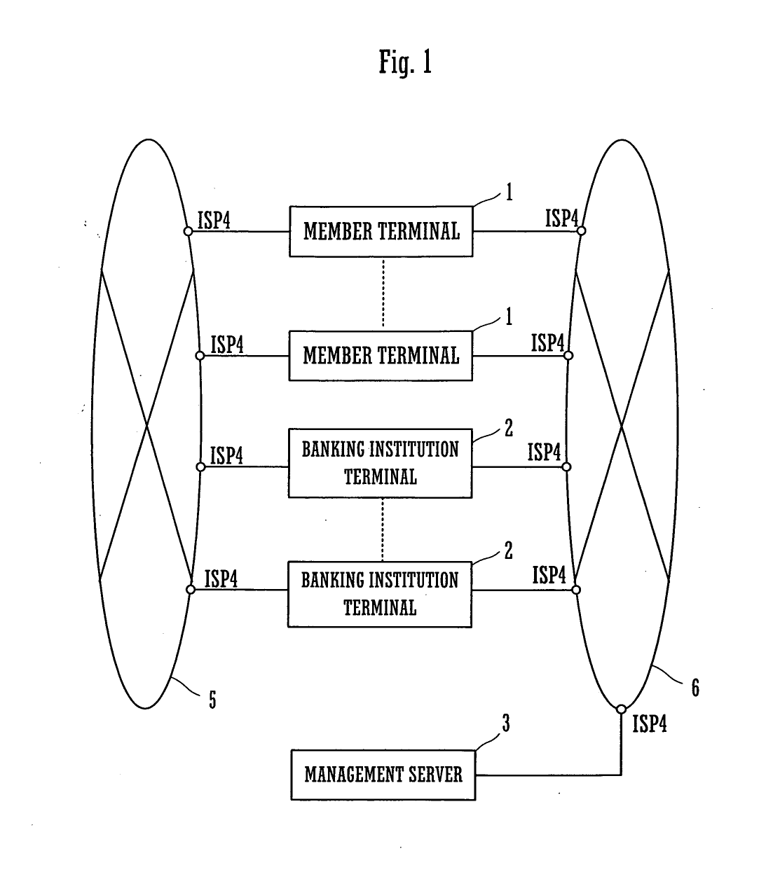

FIG. 1 generally illustrates an example of a network system of the invention. The network system illustrated in FIG. 1 includes member terminals 1 for consumers, member terminals 1 installed at stores, companies, and the like, and banking institution terminals 2 installed at least one banking institution, such as banks. The terminals 1 and 2 are connected to the network via a provider (ISP) 4. The network system includes the Internet 5, and a dedicated network 6 different from the Internet 5. A consumer, a store, a company and a banking institution, becoming a member of an established organization, are granted a right (access right) to be connected to the dedicated network 6. The member can thus exchange information with another member via the dedicated network 6. As illustrated in FIG. 1, different providers ISP 4 are illustrated for the Internet 5 and the dedicated network 6, but the providers ISP 4 may be shared by the Internet 5 and the dedicated network 6. It is sufficient if the terminals 1 and 2 are connected to the dedicated network 6. The terminals 1 and 2 are not necessarily connected to the Internet 5.

The management server 3 is managed and operated by the established organization or a supervisor who is entrusted by the organization. The management server 3 includes a computer and a storage, and is connected to the dedicated network 6. The management server 3 is installed at a management institution that exchanges information with the terminals 1 and 2, and generally manages and stores information. In one embodiment, the management server 3 may be installed at one of the providers ISP 4.

More specifically, the dedicated network 6 assists in electronic payment or the like among members registered in the established organization. For example, the dedicated network 6 assists in settlement in general business transactions, including the writing or receiving of a bill by a shop owner, a directive for transferring (i.e., payment of) money from a purchaser to an account in a bill issuer's banking institution, and issuance of a receipt of the directive. The dedicated network 6 exchanges a variety of digital documents in not only electronic payment but also business transactions. The terminals 1 and 2 produce a variety of documents as an electronic file. The electronic file may be exchanged among the terminals 1 and 1, or the terminals 1 and 2 via the management server 3.

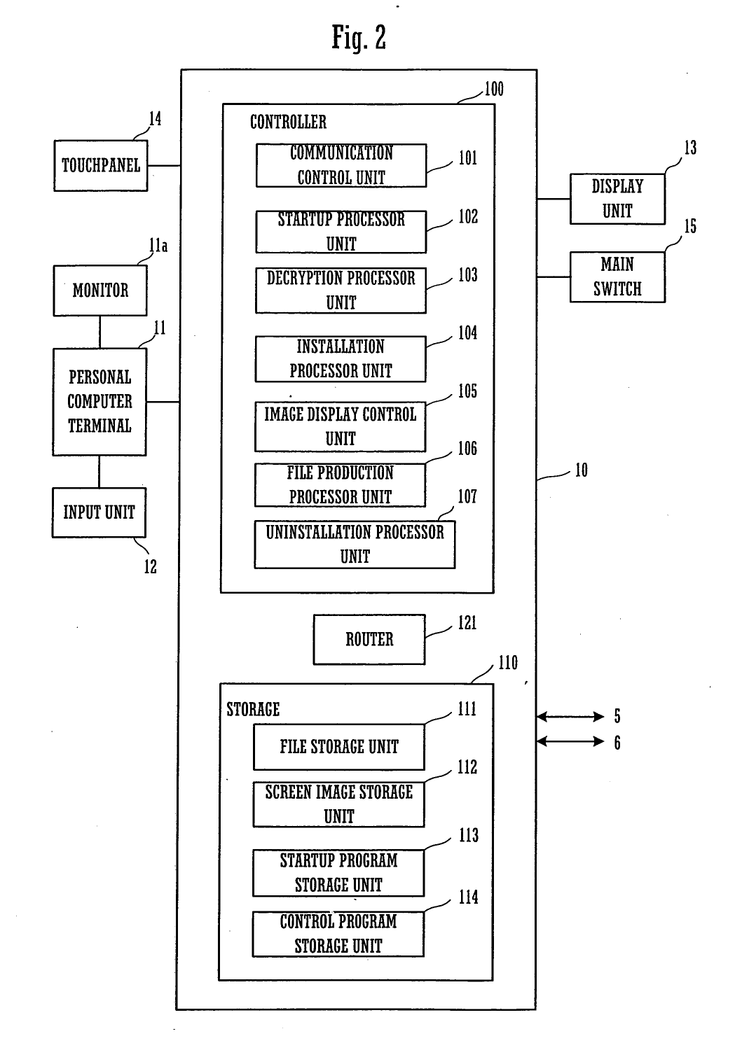

FIG. 2 is a function block diagram of the member terminal 1. As illustrated in FIG. 2, the member terminal 1 includes a modem 10 (information processing device) connected to the provider ISP 4. As necessary, the member terminal 1 includes, as means for auxiliary producing or viewing a file, a personal computer (hereinafter referred to as a personal computer terminal) 11 and an input unit 12. The personal computer terminal 11 is connected to the modem 10 and includes a monitor 11a having a liquid-crystal display or the like. The input unit 12 is connected to the personal computer terminal 11, and includes a mouse and a keyboard for inputting information, and placing an instruction to display and process information.

The modem 10 has a predetermined shape, such as of a rectangular parallelepiped casing, and includes a modulator and a demodulator for performing an intended function. The modem 10 also has input and output wiring terminals on an appropriate location on the surface thereof. The modulator modulates information, generated by the personal computer terminal 11 and also generated by the modem 10 as described below, to a signal in a form that that permits the signal to be transferred along one of the Internet 5 or the dedicated network 6. The demodulator demodulates a signal received via one of the Internet 5 or the dedicated network 6 to a signal in a form that permits the signal to be processed by one of the modem 10 and the personal computer terminal 11.

The modem 10 includes a display unit 13 and a touchpanel 14 on an appropriate location on the surface thereof. The display unit 13 having a liquid-crystal display panel or a plasma display panel displays an image. The touchpanel 14 is laminated on top of the display unit 13. The touchpanel 14 may be one of known electrical, ultrasonic, optical, and pressure-sensitive elements. On each image (such as a button) displayed on the display unit 13, the storage 110 to be discussed later pre-stores a display position of the image and coordinates of a pressing operation position on the touchpanel 14 mapped to the display position. The information about a press detection position thus serves to identify which button image displayed on the display unit 13 has been selected. The main switch 15 performs a power on/off operation on the modem 10 (the terminal 1).

The modem 10 further includes a controller 100 having a CPU (Central Processing Unit) and the storage 110 (ROM and RAM). The controller 100 executes a program stored on the storage 110. The controller 100 thus functions as communication control unit 101, startup processor unit 102, decryption processor unit 103, installation processor unit 104, image display control unit 105, file production processor unit 106, and uninstallation processor unit 107.

The storage 110 includes file storage unit 111, screen image storage unit 112, startup program storage unit 113, and control program storage unit 114. The startup program storage unit 113 has a ROM area, and stores a startup program for installing a variety of application programs (control program) perform the process of the modem 10. In one embodiment, the management server 3 installs on the storage 110 a variety of application programs causing the modem 10 to produce an electronic file and to exchange the electronic file. At the startup of the modem 10 in response to the power-on operation of the main switch 15, the control program is installed by the startup program. The control program is uninstalled in response to the power-off operation of the main switch 15. In this way, the secrecy of the control program and the internal files are ensured as much as possible even if the modem 10 is stolen.

The communication control unit 101 performs a process of a controller (not illustrated) of a router 121. The communication control unit 101 sorts (routes) files to be transmitted, the files being those from the personal computer terminal 11, or those produced by the touchpanel 14 and the controller 100 in the modem 10, to the Internet 5 or to the dedicated network 6 as a packet signal having a predetermined format. The communication control unit 101 also routes an incoming packet signal from the outside to the model 10 or the personal computer terminal 11. The communication control unit 101 also performs a process to identify address information representing a transmission destination attached to a predetermined position of each packet as a transmission signal or a reception signal. More specifically, the communication control unit 101 determines whether the address information indicates a global IP address defined by the standard of the Internet 5, or a predetermined local IP address for the dedicated network 6, for example, complying with the Ethernet (registered trademark) or the like different from the global IP address in the concatenation method (the predetermined local IP address being discriminated from the global IP address in format).

In response to the power-on of the modem 10, the startup processor unit 102 reads an OS program stored on a predetermined area of the storage 110, and starts up the modem 10. More in detail, if the main switch 15 is switched on, a program referred to as IPL (Initial program Loader) is initiated. An area referred to as MBR (Master Boot Record) at the head of a predetermined region of the storage 110 is read. Then an area in the predetermined region is selected for an OS startup from the content of MBR. A program stored at a boot sector in the selected area is read. The program causes the OS to be expanded onto a memory, thereby executing the startup operation. The startup processor unit 102 further performs a series of processes related to the startup operation, and instructs the decryption processor unit 103 and the installation processor unit 104 to perform a necessary process.

The series of processes performed by the startup processor unit 102 includes outputting a transmission request signal for the control program to the management server 3, receiving the merge information of the encrypted control program and the encrypted authentication information from the management server 3, placing an instruction to cause the decryption processor unit 103 to decrypt the received merge signal, returning the decrypted authentication signal to the management server 3, receiving an install permission signal from the management server 3, and instructing the installation processor unit 104 to perform an install process in response to the reception of the install permission signal.

As described below, the decryption processor unit 103 separates the control program and the authentication information from the merge information of individually encrypted control program and authentication information, and then decrypts the control program and the authentication information. The control program and the authentication information respectively include a plurality of packets. The decryption processor unit 103 acquires a scrambling rule corresponding to a decryption rule attached to a header area of a predetermined packet out of the plurality of packets respectively forming the control program and the authentication information, and performs a decryption process on the control program and the authentication information using the scrambling rule.

The installation processor unit 104 installs on the control program storage unit 114 as a RAM the control program as an application program, the application program being part of the startup process of the modem 10. If the main switch 15 is switched off, the uninstallation processor unit 106 deletes the control program stored on the control program storage unit 114.

As described below, the management server 3 encrypts the control program and the like and transmits the encrypted control program to the terminal 1 having transmitted a transmission request. The management server 3 attaches a decryption rule (key) to a header area of a packet generated in compliance with the TCP/IP standard.

The image display control unit 105 causes the display unit 13 to display a produced file and a received file. The image display control unit 105 displays a variety of button images that assist in file production, and executes a display process responsive to a button specified via the touchpanel 14. The file production processor unit 106 assists in a production process of a file such as of a bill using the touchpanel 14. The file production process, file communication process, file management process, and image display process for these processes are executed in accordance with the application program, i.e., the above-described control program.

The banking institution terminal 2, which is not discussed in detail, is intended to digitally perform settlement of transactions among members. The banking institution terminal 2 includes a controller as a computer performing a settlement process, and a storage storing settlement contents as a history. These processes are also executed by the application program of the banking institution.

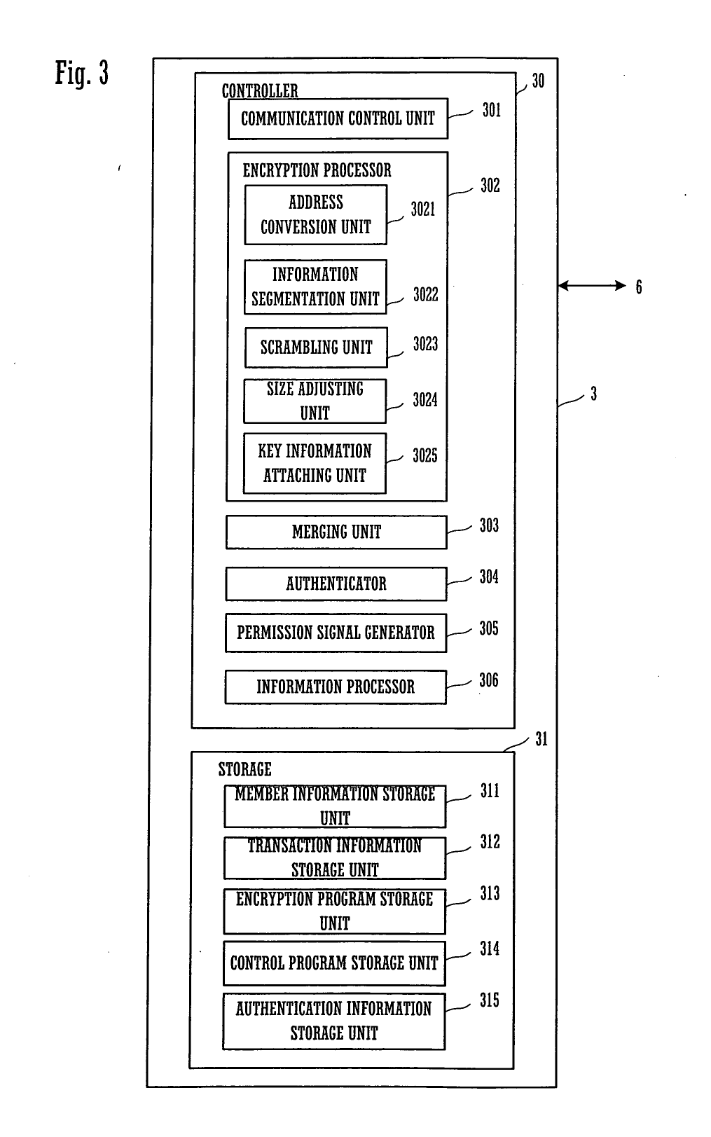

FIG. 3 is a function block diagram of the management server 3. As illustrated in FIG. 3, the management server 3 includes at least a controller 30, including a CPU, and a storage 31. The controller 30 executes the program stored on the storage 31, and thus functions as communication control unit 301, encryption processor 302, merging unit 303, authenticator 304, permission signal generator 305, and information processor 306. The storage 31 includes member information storage unit 311, transaction information storage unit 312, encryption program storage unit 313, control program storage unit 314, and authentication information storage unit 315.

The communication control unit 301 relays information (such as a file) between terminals 1 and 1, or between terminals 1 and 2. When files are exchanged among members, the management server 3 receives all the files. The information processor 306 in the management server 3 stores the files on the transaction information storage unit 312 in a chronological order and preferably on a per member basis.

Upon receiving the transmission request signal from one terminal 1, the communication control unit 301 transmits, in the form of the merge information, the control program and the authentication information encrypted by the encryption processor 302 to the terminal 1 having transmitted the transmission request.

The encryption processor 302 individually encrypts the control program stored on the control program storage unit 314 and the authentication information stored on the authentication information storage unit 315, as encryption target information, in accordance with an encryption program stored on the encryption program storage unit 313. The encryption processor 302 includes address conversion unit 3021, information segmentation unit 3022, scrambling unit 3023, size adjusting unit 3024, and key information attaching unit 3025. The encryption processor 302 performs the encryption process on each of the control program and the authentication information.

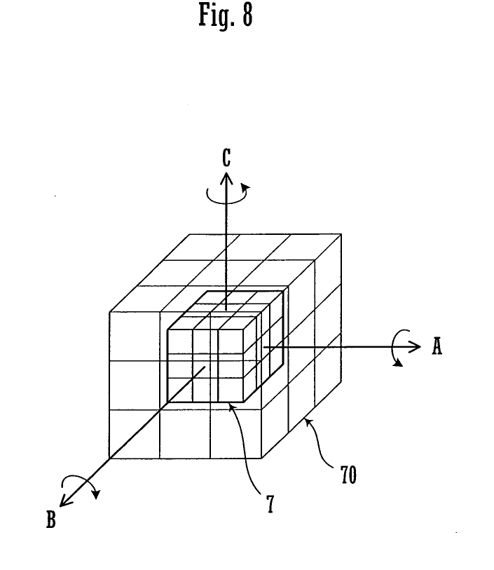

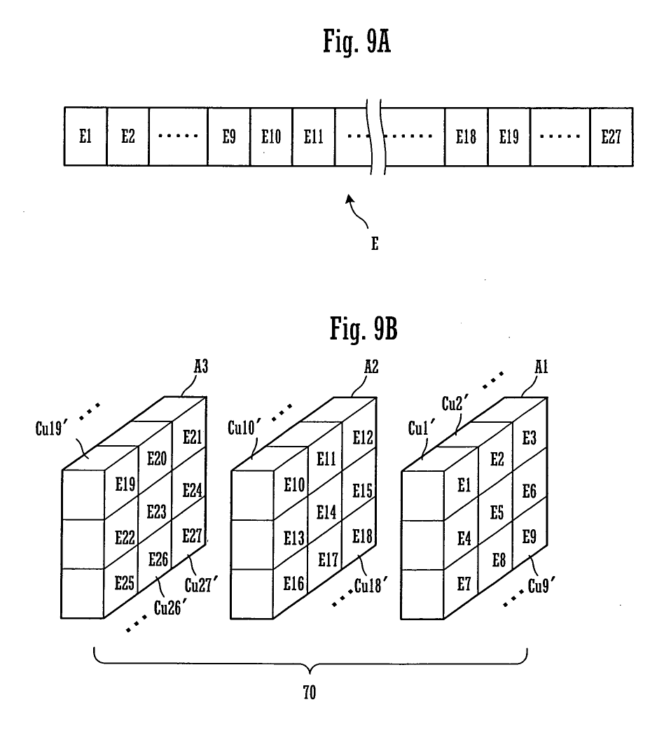

The address conversion unit 3021 calculates an address (shift address) after a cube Cu shifts in response to a rotation of a virtual geometric structure 7 to be discussed later. The address conversion unit 3021 also calculates an address (shift address) after a cube Cu′ shifts in response to a rotation of a virtual geometric structure 70 of FIGS. 8 and 9 to be discussed later. According to the embodiment, the address conversion unit 3021 causes the virtual geometric structure 7 and the virtual geometric structure 70 to rotate in unison, i.e., by the same amount of rotation about the same axis such that an amount of information of a scrambling rule is reduced. When the virtual geometric structure 7 and the virtual geometric structure 70 are rotated in unison and at the same time, an address calculation process performed on only one of the virtual geometric structures is sufficient. The arithmetic process is not only reduced in burden but also accelerated. The virtual geometric structure 7 and the virtual geometric structure 70 are not necessarily rotated in unison. The virtual geometric structure 7 may be rotated independently of the virtual geometric structure 70.

The information segmentation unit 3022 individually segments a control program D and authentication information E into predetermined information units. The scrambling unit 3023 re-arranges (scrambles) segmented information units in accordance with a shift address. The size adjusting unit 3024 generates the virtual geometric structures 7 and 70 responsive to the number of information units. The key information attaching unit 3025 adds decrypted information to a header area of a transmission packet. If the virtual geometric structure 7 and the virtual geometric structure 70 are rotated independently of each other, the key information attaching unit 3025 adds the decrypted information of both the control program D and the authentication information E to the header areas of the transmission packets.

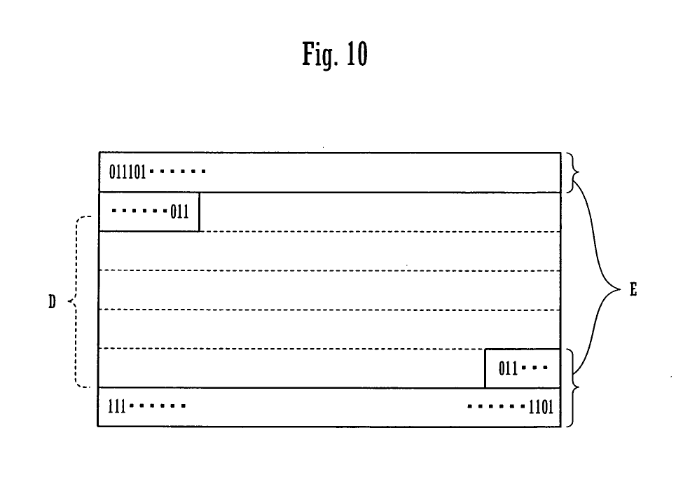

The merging unit 303 merges the encrypted control program D and the encrypted authentication information E into a series of information segments. The series of information segments are illustrated in FIG. 10. More specifically, information segments are arranged over a plurality of rows from a first row to a final row as illustrated in FIG. 10. The control program D is embedded in the middle of the authentication information E. Where to embed the control program D in the authentication information E may be preset, for example, at the intermediate position of the authentication information E.

The authentication information E may be one type, or a plurality of types may be set as the authentication information E and then selected as appropriate in one embodiment. The authentication information E ensures with a higher probability the certainty that the terminal 1 is an appropriate terminal. If viewed from the terminal 1 on the other hand, the authentication information E also ensures with a higher probability the certainty that the management server 3 is an appropriate server. In one embodiment, the authentication information may be varied information including information different at the startup of the terminal 1 (such as information related to an operation history and a file transmission and reception history of the terminal 1, or information related to the startup time of the terminal 1). The authentication information may include information unique to the terminal 1 (such as part of an IP address included in the transmission request signal). If the authentication information E is one type, the authentication information E may be pre-segmented and then stored. In this way, the information segmentation unit 3022 and the size adjusting unit 3024 become unnecessary. The control program D and the authentication information E may have substantially the same number of information units (i.e., the virtual geometric structures 7 and 70 have at least the same size). If the control program D and the authentication information E are scrambled with the same scrambling rule, the key information attaching unit 3025 may attach a key to only either of the control program D and the authentication information E.

The authenticator 304 checks the decrypted authentication information E returned from the terminal 1 against the original authentication information stored on the authentication information storage unit 315 in order to determine whether the two pieces of information match each other or not. If the two pieces of information match each other, the authenticator 304 authenticates that the terminal 1 is appropriate. If the two pieces of information fail to match each other, the authenticator 304 determines that the terminal 1 has a fraudulent identity.

If the authentication result of the authenticator 304 shows a match, the permission signal generator 305 determines that the terminal 1 is an appropriate terminal, and generates a permission signal to install the application program as the control program, and instructs the communication control unit 301 to transmit the permission signal. If the authentication result of the authenticator 304 shows a no-match, the permission signal generator 305 determines that the terminal 1 is an illegal terminal 1, and does not generate a permission signal to install the application program. As a result, the permission signal to install the application program is not transmitted to the terminal 1. In one embodiment where the permission signal is pre-generated and stored on a predetermined storage unit, the permission signal generator 305 performs, as the generation process of the permission signal, a process to read from the predetermined storage unit the permission signal in response to the match determination result from the authenticator 304 and to set the read permission signal to be in a transmission ready state.

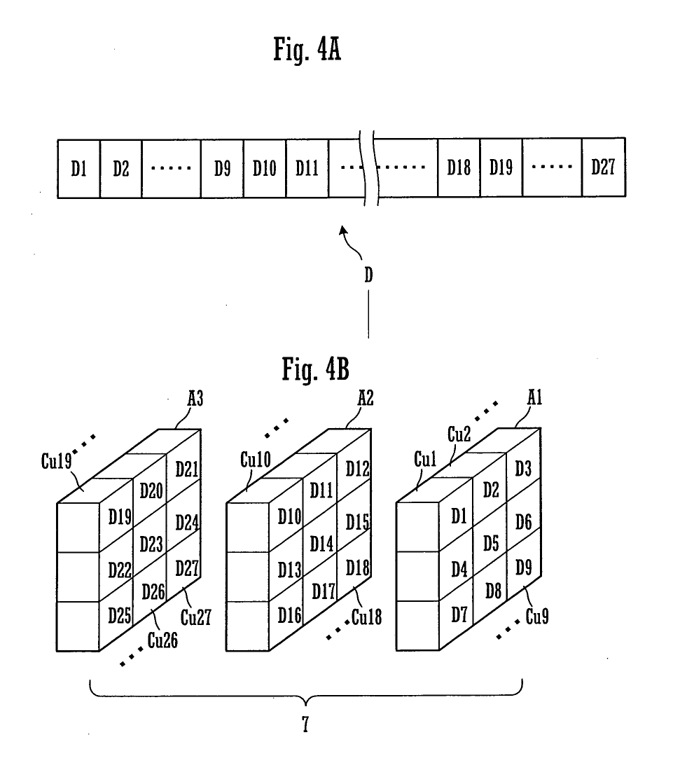

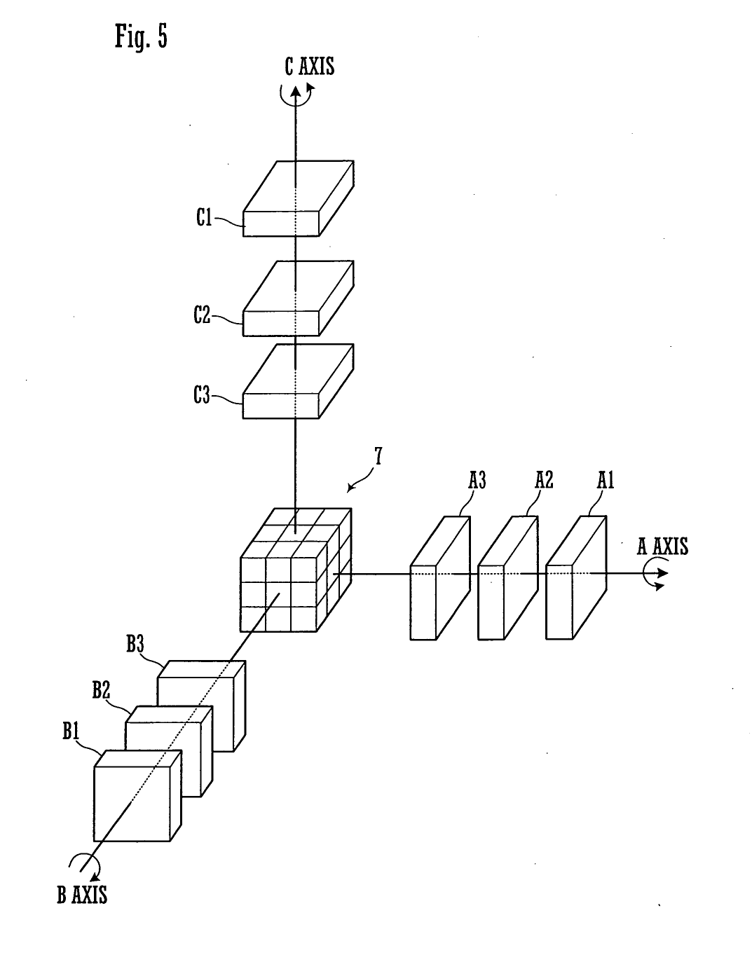

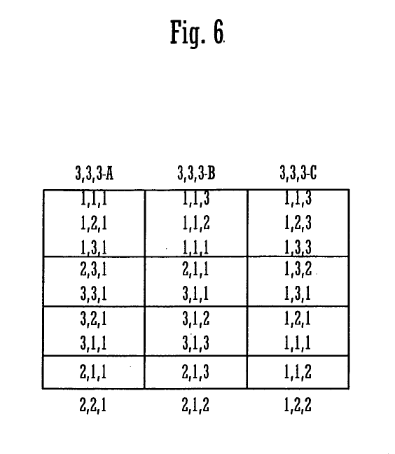

FIGS. 4-6 illustrate the principle of the encryption process performed using the geometric structure. FIG. 4A illustrates information units into which the control program as an encryption target is segmented, and FIG. 4B illustrates a relationship between each information unit and the address of each cube Cu forming the geometric structure. FIG. 5 illustrates a rotation of the geometric structure about each axis. FIG. 6 illustrates shift characteristics of addresses of the cube Cu that shift in response to the rotation of the geometric structure. In the above discussion, elements forming the virtual geometric structure 7 are described as a rectangular parallelepiped because the vision of the cube enhances ease of understanding. The shape of the element is not important, and the arrangement of the elements and the method of rotation of the elements are important.

In the embodiment, the virtual geometric structure 7 has three cubes (elements) Cu arranged in each of the three axes. As illustrated in FIG. 5, each cube Cu rotates about each of the three axes, i.e., A axis, B axis, and C axis. If viewed from the A axis, a first tier A1, a second tier A2, and a third tier A3 individually rotate about the A axis. If viewed from the B axis, a first tier B1, a second tier B2, and a third tier B3 individually rotate about the B axis. If viewed from the C axis, a first tier C1, a second tier C2, and a third tier C3 individually rotate about the C axis. Each of the axes agrees with a normal line to the center cube Cu, and corresponds to the center axis of the cube Cu.

As illustrated in FIG. 4B, cubes Cu1-Cu27 identify positions thereof within the virtual geometric structure 7 of the cubes. The cubes Cu1-Cu27 are mapped to addresses of the cubes in response to the rotation of the virtual geometric structure 7. The addresses are described in a fixed format as (C axis direction, B axis direction, C axis direction)=(1,1,1)-(3,3,3).

FIG. 4B illustrates the first tier A1, the second tier A2, and the third tier A3 viewed from the A axis, and the addresses of the cubes Cu1-Cu27 are represented as (1,1,1)-(3,3,3). More specifically, cubes Cu1-Cu9 expanding from the left end on the first row to the right end on the third row of the first tier A1 respectively correspond to (1,1,1)-(3,3,1). Cubes Cu10-Cu18 expanding from the left end on the first row to the right end on the third row of the second tier A2 respectively correspond to (1,1,2)-(3,3,2). Cubes Cu19-Cu27 expanding from the left end on the first row to the right end on the third row of the third tier A3 respectively correspond to (1,1,3)-(3,3,3). Plain text of FIG. 4A prior to encryption is segmented into information units D1-D27 every predetermined bits. The information units D1-D27 are assigned to the cubes Cu1-Cu27 as illustrated in FIG. 4B.

The information reading is performed in the order of addresses (1,1,1) . . . (3,3,1), (1,1,2) . . . (3,3,2), (1,1,3) . . . (3,3,3). In the state of the virtual geometric structure 7 prior to the rotation, the cubes Cu1-Cu27 match the addresses thereof, in other words, information units D1-D27 match the addresses thereof. If the virtual geometric structure 7 remains unrotated (or in the state thereof prior to rotation), the information units D are read in the order of D1-D27 (in other words not scrambled).

If the virtual geometric structure 7 rotates in any order of the A axis-the C axis, the mapping relationship between the cubes Cu and the addresses is modified. The rotation of the virtual geometric structure 7 about each axis is performed in a spiral-like shifting fashion, in which the addresses of the cubes Cu of the embodiment are successively shifted about each rotation axis from outer cube to inner cube. For example, FIG. 6 illustrates three digit numbers, which are shifted as addresses of the cubes Cu about each of the A axis, the B axis, and the C axis.

In the first tier A1 about the axis A, (1,1,1) is mapped to the cube Cu1, (1,2,1) is mapped to the cube Cu2, (1,3,1) is mapped to the cube Cu3, (2,3,1) is mapped to the cube Cu6, (3,3,1) is mapped to the cube Cu9, (3,2,1) is mapped to the cube Cu8, (3,1,1) is mapped to the cube Cu7, (2,1,1) is mapped to the cube Cu4, and (2,2,1) is mapped to the cube Cu5. A similar relationship is established because the second tier A2 and the third tier A3 rotate about the same axis.

In the first tier B1 about the axis B, (1,1,3) is mapped to the cube Cu19, (1,1,2) is mapped to the cube Cu10, (1,1,1) is mapped to the cube Cu1, (2,1,1) is mapped to the cube Cu4, (3,1,1) is mapped to the cube Cu7, (3,1,2) is mapped to the cube Cu16, (3,1,3) is mapped to the cube Cu25, (2,1,3) is mapped to the cube Cu22, and (2,1,2) is mapped to the cube Cu13. A similar relationship is established because the second tier B2 and the third tier B3 rotate about the same axis.

In the first tier C1 about the axis C, (1,1,3) is mapped to the cube Cu19, (1,2,3) is mapped to the cube Cu20, (1,3,3) is mapped to the cube Cu21, (1,3,2) is mapped to the cube Cu12, (1,3,1) is mapped to the cube Cu3, (1,2,1) is mapped to the cube Cu2, (1,1,1) is mapped to the cube Cu1, (1,1,2) is mapped to the cube Cu10, and (1,2,2) is mapped to the cube Cu11. A similar relationship is established because the second tier C2 and the third tier C3 rotate about the same axis.

If the virtual geometric structure 7 is rotated about the A axis counterclockwise by one pitch as illustrated in FIG. 6 (in a first rotation), an initial address (1,1,1) mapped to a reference cube Cu, such as the cube Cu1, is withdrawn. And then an address (1,1,1) is set as a shift address corresponding to an initial address (1,2,1) mapped to the cube Cu2. The cubes Cu are successively shifted by one address and then a shift address (3,1,1) is set for an initial address (2,1,1) mapped to the cube Cu4. Finally, a shift address (2,1,1) is set for the first withdrawn initial address (1,1,1) mapped to the cube Cu1. In the address shifting through the rotation, an address newly shifted at each rotation (shift address) is tracked by calculating an address change relationship of the addresses in FIG. 6. The address conversion unit 3021 successively stores pairs of initial addresses and shift addresses for the cubes Cu in practice. Each time a next rotation instruction is placed, an immediately preceding address is converted to a new shift address (subsequent to shifting).

As seen in FIG. 6, the cube positioned at an address, for example, an address (1,1,1) rotates about each of the A axis, the B axis, and the C axis. With respect to the position immediately preceding the rotation about a given axis, all the addresses of the cubes Cu other than cubes Cu5, Cu14, and Cu23 may be shifted about the axis A, all the addresses of the cubes Cu other than cubes Cu13, Cu14, and Cu15 may be shifted about the axis B, and all the addresses of the cubes Cu other than cubes Cu11, Cu14, and Cu11 may be shifted about the axis C. If the virtual geometric structure 7 is rotated in a variety of fashions about each axis, the initial addresses set on the cubes Cu are significantly scrambled. A scrambling rule is the order of selection of the rotation axes of the virtual geometric structure 7 and the direction of rotation and an amount of rotation at each rotation axis of the virtual geometric structure 7 (an amount of rotation of one cube is referred to as 1 pitch, and one rotation is 8 pitches corresponding to the eight cubes along the external side of the tier (=4(n−1); n=3)). The scrambling rule may be formulated such that a plurality of tiers is rotated if a rotation axis is selected. For example, in one embodiment, the first tier A1 is rotated counterclockwise about the A axis by 1 pitch and the third tier A3 is rotated clockwise about the A axis by 2 pitches.

The scrambling unit 3023 references the shift address in each cube Cu after the rotation process is performed in accordance with the scrambling rule, and re-arranges the cubes Cu in accordance with the shift addresses and the initial addresses. More specifically, the scrambling unit 3023 specifies the cube Cu in accordance with the order of the shift addresses, reads the information unit D pre-mapped to the specified cube Cu, and re-arranges the information unit D in a sequence. Transmission is performed in accordance with the sequence.

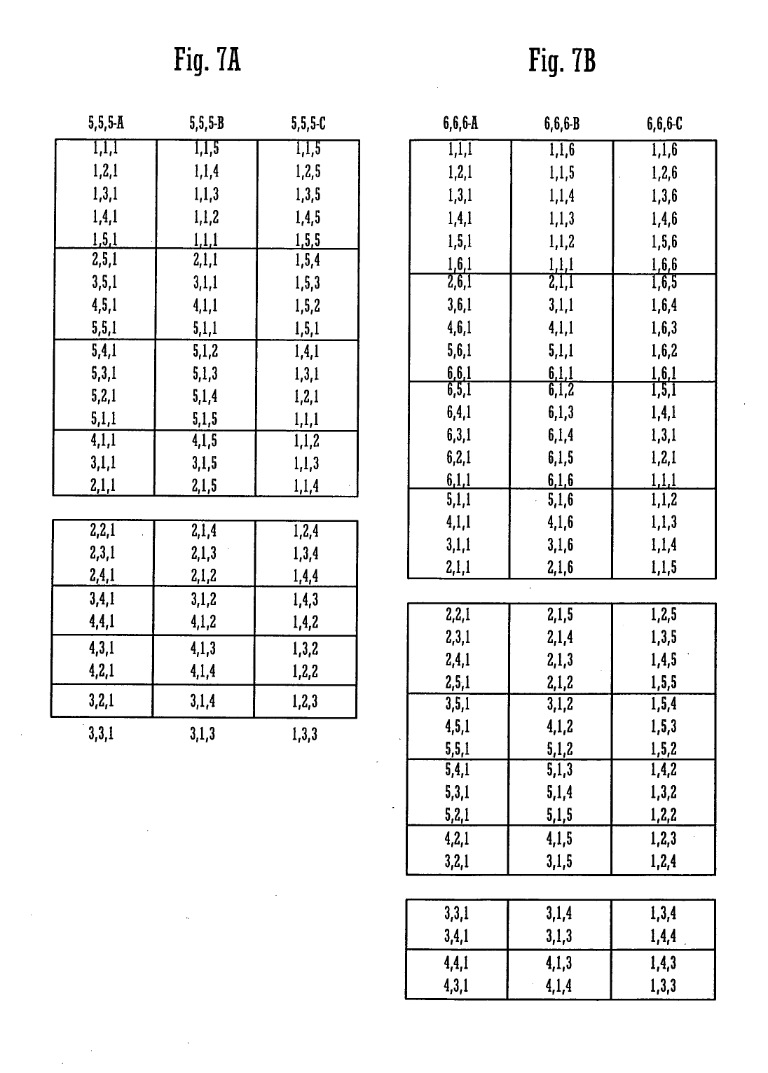

FIG. 7 illustrate shift characteristics of the addresses shifting in response to the rotation of the cubes in another embodiment. FIG. 7A illustrates the shift characteristics with n being 5, and FIG. 7B illustrates the shift characteristics with n being 6. In the same manner as in FIG. 4, the reading order of the information units from the first row to the last row, starting with the top left cube Cu1 on the first row toward the bottom right cube, is set on the cubes Cu1-Cu125 of FIG. 7A and on the cubes Cu1-Cu216 of FIG. 7B.

As illustrated in FIG. 7A, the reading order about the A axis listed at [5,5,5,-A] on the first tier A1 is addresses (1,1,1), (1,2,1) . . . (2,1,1) on the outer side of the first tier A1, followed by (2,2,1) . . . (3,2,1) on the inner side of the first tier A1, and then (3,3,1) at the center of the first tier A1. These addresses correspond to cubes Cu1, Cu2, . . . Cu6, Cu7, . . . Cu12, and Cu13. In the embodiment, the addresses of the cubes Cu are successively shifted from the outer to inner side about the rotation axis, in other words, shifted in a spiral fashion. The reading order of the second tier A2, . . . , the fifth tier A5 are similar because these are also rotated about the same axis as that of the first tier A1. Similarly, the reading order is also spirally shifted about the B axis and the C axis as labeled with [5,5,5,-B] and [5,5,5,-C]. The center is the cube Cu13. If viewed from the A axis, the B axis, and the C axis, a change in the addresses follows a certain relationship, and the shifting of the addresses is calculated by making use of the change.

As illustrated in FIG. 7B, the reading order about the A axis listed at [6,6,6,-A] on the first tier A1 is addresses (1,1,1), (1,2,1) . . . (2,1,1) on the outer side of the first tier A1, followed by (2,2,1) . . . (3,2,1) on the inner side of the first tier A1, then further inside (3,3,1), and finally (4,3,1) of the first tier A1. These addresses correspond to cubes Cu1, Cu2, . . . Cu6, Cu7, . . . Cu14, Cu15, . . . Cu21. In the embodiment, the addresses of the cubes Cu are successively shifted from the outer to inner side about the rotation axis, in other words, shifted in a spiral fashion. The reading orders of the second tier A2, . . . , the sixth tier A6 are similar because these are also rotated about the same axis as that of the first tier A1. Similarly, the reading order is also spirally shifted about the B axis and the C axis as labeled with [6,6,6,-B] and [6,6,6,-C]. The center is in the middle of cubes Cu15, Cu16, Cu21, and Cu22. If viewed from the A axis, the B axis, and the C axis, a change in the addresses follows a certain relationship, and the shifting of the addresses is calculated by making use of the change. The value n may be n=2, n=4, or n=7 or larger. If n is an odd number, the center of rotation is aligned with the center cube Cu, and the calculation of the address shifting is easy.

FIGS. 8-10 illustrate an encryption process of the authentication information performed using the geometric structure. FIG. 8 is an image that presents in an easy-to-see fashion the relationship between the virtual geometric structure 7 for the control program and the virtual geometric structure 70 for the authentication information. The virtual geometric structures 7 and 70 are analogous in shape to each other, and placed in a dual arrangement. FIG. 9A illustrates information units into which the authentication information is segmented, and FIG. 9B illustrates a relationship between each information unit E and an address of each cube Cu′ forming the virtual geometric structure. FIG. 10 illustrates the control program and the authentication information in the merged state thereof. The cubes Cu1′-Cu27′ of the virtual geometric structure 70 are rotatable in the same manner as the virtual geometric structure 7.

Referring to FIG. 9B, the cubes Cu1′-Cu27′ identify the positions thereof within the virtual geometric structure 70. The cubes Cu1′-Cu27′ are mapped to the addresses of the cubes that shift in response to the rotation of the virtual geometric structure 70. The addresses (C axis direction, B axis direction, A axis direction)=(1,1,1)-(3,3,3) remain unchanged in format.

FIG. 9B illustrates the first tier A1′, the second tier A2′, and the third tier A3′ viewed from the A axis, and the addresses of the cubes Cu1′-Cu27′ are represented as (1,1,1)-(3,3,3). More specifically, cubes Cu1′-Cu9′ expanding from the left end on the first row to the right end on the third row of the first tier A1′ respectively correspond to (1,1,1)-(3,3,1). Cubes Cu10′-Cu18′ expanding from the left end on the first row to the right end on the third row of the second tier A2′ respectively correspond to (1,1,2)-(3,3,2). Cubes Cu19′-Cu27′ expanding from the left end on the first row to the right end on the third row of the third tier A3′ respectively correspond to (1,1,3)-(3,3,3). The authentication information of FIG. 9A prior to encryption is segmented into information units E1-E27 every predetermined bits. The information units E1-E27 are assigned to the cubes Cu1′-Cu27′ as illustrated in FIG. 9B. The information assignment remains identical to the information assignment of the control program of FIG. 4.

The information reading is performed in the order of addresses (1,1,1) . . . (3,3,1), (1,1,2) . . . (3,3,2), (1,1,3) . . . (3,3,3). In the state of the virtual geometric structure 70 prior to the rotation, the cubes Cu1′-Cu27′ match the addresses thereof, in other words, information units E1-E27 match the addresses thereof in the sequences thereof. If the virtual geometric structure 7 remains unrotated (or in the state thereof prior to rotation), the information units E are read in the order of E1-E27 (in other words not scrambled).

If the A axis-the C axis of the virtual geometric structure 70 rotate in any order, the mapping relationship between the cubes Cu′ and the addresses is modified. The rotation of the virtual geometric structure 70 is performed about each axis, in which the addresses of the cubes Cu′ of the embodiment are successively shifted about each rotation axis from outer cubes as in FIGS. 4-6, in a so-called spiral-like shifting fashion.

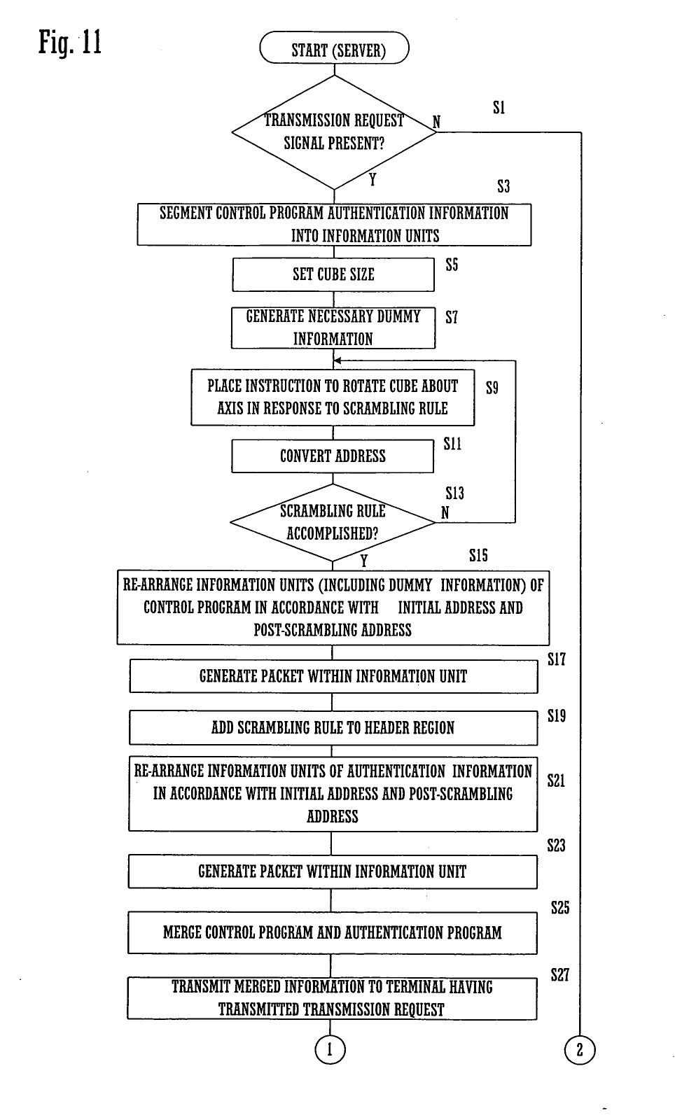

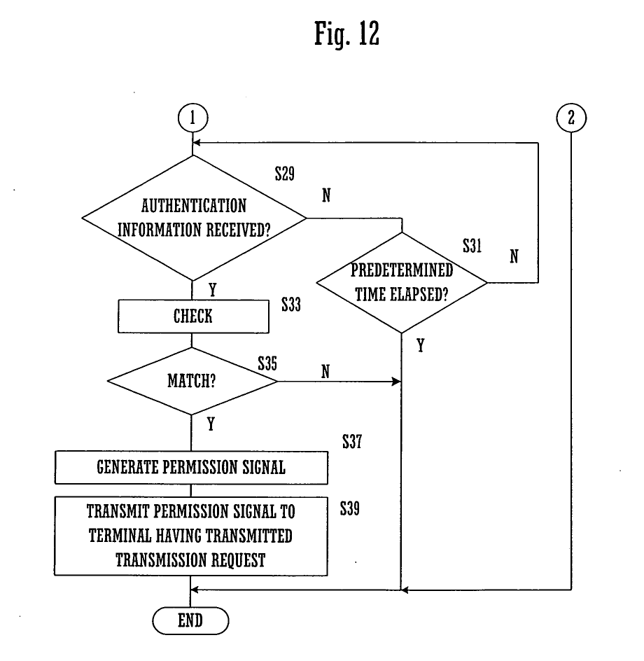

FIGS. 11 and 12 are flowcharts of the startup process executed by the controller 30 in the management server 3. Referring to FIG. 11, the controller 30 determines whether the transmission request signal has been received from the terminal 1 (step S1). If no transmission request signal has been received, processing exits the main flow of the startup process. If a transmission request signal has been received, the encryption processor 302 performs a segmentation process (see FIG. 4A) on the information units of the control program D, and a segmentation process (see FIG. 9A) on the information units of the authentication information E (step S3). The information units of these pieces of information are segmented by a predetermined bit unit. If the number of segmented information units D is 27 or less, the virtual geometric structure 7 having three elements (cubes) arranged in each axis as illustrated in FIGS. 4-6 is used.

If the number of segmented information units D is above 27 but equal to or less than 64, the virtual geometric structure having four elements (cubes) arranged in each axis is used. More specifically, the size adjusting unit 3024 uses the virtual geometric structure 7 having as the number of cubes in each axis the cubic root of the number of information units D (step S5). Necessary dummy information is generated (step S7). If the number of information units D is 25 with the number of cubes Cu being 27, two pieces of dummy information is generated, and a total number of information units becomes equal to the number of cubes Cu. The dummy information may include information that identifies the dummy information. The dummy information is thus removed after being decrypted at the receiver side. In one embodiment where the virtual geometric structure 70 has the same structure as that of the virtual geometric structure 7, a cube having the same cube size as the cube size of the virtual geometric structure 7 is set in step S5.

The controller 30 places an instruction to cause the virtual geometric structures 7 and 70 to rotate about the axis in unison in accordance with the scrambling rule (step S9). The scrambling rule is stored on the encryption program storage unit 313, and is then read and executed by the encryption processor 302. A variety of scrambling rules are prepared. One of the scrambling rules may be selected and executed. Alternatively, the scrambling rule may be generated at random in each time of need. Preferably, the scrambling rule may instruct the rotation to be performed at least on all the three axes. The rotation instruction may be placed repeatedly on the same axis with a different axis used therebetween in order to result in a high degree of scramble. For example, according to one scrambling rule, the rotation instruction is given on the A axis and the B axis in that order, and the rotation instruction may be given on the A axis again. Preferably, the scrambling rule may include at least three rotations including the rotation instruction for each of the axes. A maximum number of instructed rotations may be set depending on the scramble state determined by the rotation pitch and the like. In one embodiment, a different number of instructed rotations and a different amount of rotation pitch may be set each time of the encryption process.

The address conversion process is executed in response to the rotation (step S11). The address conversion process is performed through calculation as illustrated in FIG. 6 (in accordance with a calculation equation formulated beforehand), in other words, the virtual geometric structures 7 and 70 and the cubes Cu and Cu′ are virtually treated. The controller 30 determines whether the rotation instruction defined by the scrambling rule has been accomplished (step S13). If the rotation instruction has not been accomplished, processing returns to step S9 to place a next rotation instruction.

If the rotation instruction has been accomplished, the controller 30 re-arranges the information units (including the dummy information) D in accordance with the initial address and the address subsequent to scrambling (final shift address) (step S15).

Prior to the rotation instruction, the virtual geometric structure 7 is read in the order of the first tier A1 cubes Cu2, Cu3, Cu4, . . . Cu8, and Cu9, the second tier A2 cubes Cu10, Cu11, . . . Cu18, and the third tier A3 cubes Cu19, Cu20, . . . Cu27 in that order, in other words in the order of information units D1, D2, . . . D27 (without being scrambled). Subsequent to the scrambling, the virtual geometric structure 7 is read in the order of the addresses subsequent to the scrambling (final shift addresses). For example, the cube Cu8 having an initial address (3,2,1) may have a shift address (1,1,1) subsequent to the scrambling. The information unit D8 to be read for the eighth time prior to the scrambling is read first subsequent to the scrambling.

Each information unit is converted into a packet (step S17). The packet is preferably generated in accordance with a predetermined communication standard, typically TCP/IP standard, and has a predetermined number of bits. If the information unit has the predetermined number of bits, one information unit is one packet. In one embodiment, one information unit may be split into two, or a predetermined number of packets depending on the number of bits included in one information unit.

The key information attaching unit 3025 attaches information of the scrambling rule to a header region of a leading packet out of the generated packets (step S19). In one embodiment where one of the scrambling rules prepared is selected, information of the scrambling rule may be information identifying the scrambling rule, for example, a serial number. If the information is the scrambling rule itself, information of the number of pieces equal to the number of rotation instructions (the rotation axis, the tier of cubes, the rotation direction, and the rotation pitch) is generated. In one embodiment, the rotation direction is limited to one direction only, and the tiers are limited to the first tier. In such a case, at least (the rotation axis and the rotation pitch) is simply included. For example, if the scrambling rule is “the A axis by one pitch, the B axis by 2 pitches, the C axis by 3 pitches, and the A axis by 4 pitches,” information may be “A1,B2,C3, and A4.”

In the same manner as in step S15, the controller 30 re-arranges the information units of the authentication information E in accordance with the initial address and the address subsequent to scrambling (final shift address) (step S21). Information units E are converted into packets (step S23). The packet is preferably generated in accordance with a predetermined communication standard, typically TCP/IP standard, and has a predetermined number of bits. In the decryption of the authentication information E, the scrambling rule (i.e., decryption rule) attached in step S19 may be used. In the embodiment, the addition process of the scrambling rule is omitted.

A combination process of FIG. 10 (step S25) is performed on the information units of the control program D and the information units of the authentication information E (step S25). The combination process, i.e., the merge process is performed to embed the information units D1-D27 of the control program D to predetermined locations of the information units E1-E27 of the authentication information E. For example, the information units D1-D27 of the control program D may be embedded in the center position between the information units E13 and E14. The embedding process results in an information arrangement that is interpreted as a dual structure of the virtual geometric structure 7 and the virtual geometric structure 70 or an information arrangement that is interpreted as the control program D covered with the authentication information E. A merged packet group is then transmitted to the terminal 1 as a transmission source of the transmission request signal (step S27).

The controller 30 then determines whether the decrypted authentication information has been received (in the form of packets) from the terminal 1 as the transmission source of the transmission request signal (step S29). If not received, the controller 30 determines repeatedly within a predetermined period of time equal to time-up whether the authentication information has been received (no branch from step S31). If the predetermined period of time has elapsed, processing exits the main flow.

If the authentication information has been received within the predetermined period of time, the controller 30 checks the received authentication information against the original authentication information stored on the authentication information storage unit 315 (step S33). If the check results show that the two pieces of information match each other (step S35), a permission signal is generated (step S37), and is then transmitted to the terminal 1 as the transmission source of the transmission request (step S39). If the check results show that the two pieces of information fail to match each other, no permission signal is generated. Processing exits the main flow with no permission signal transmitted to the terminal 1 as the transmission source of the transmission request.

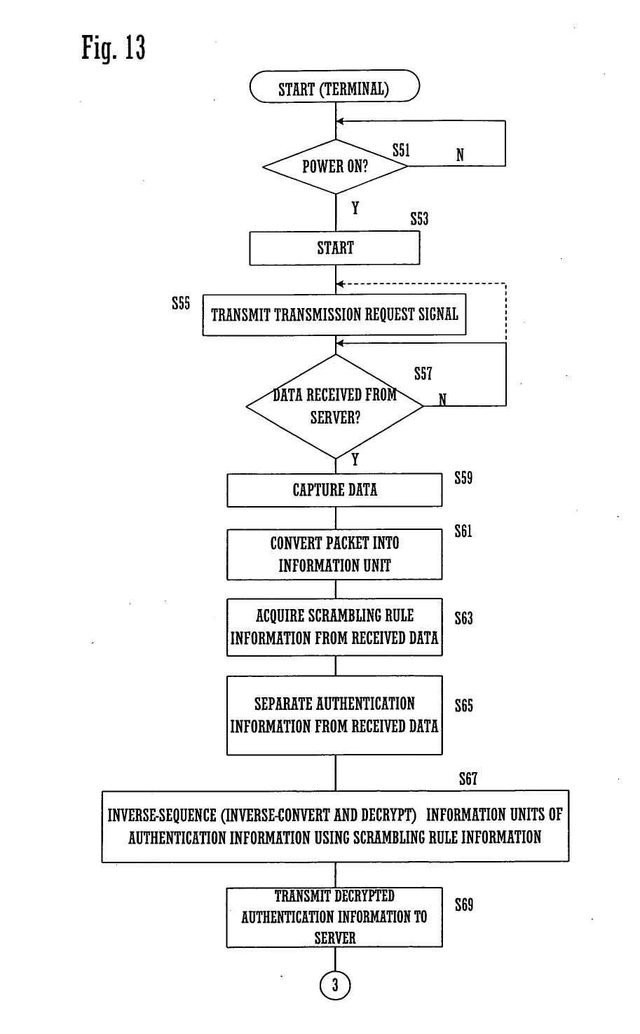

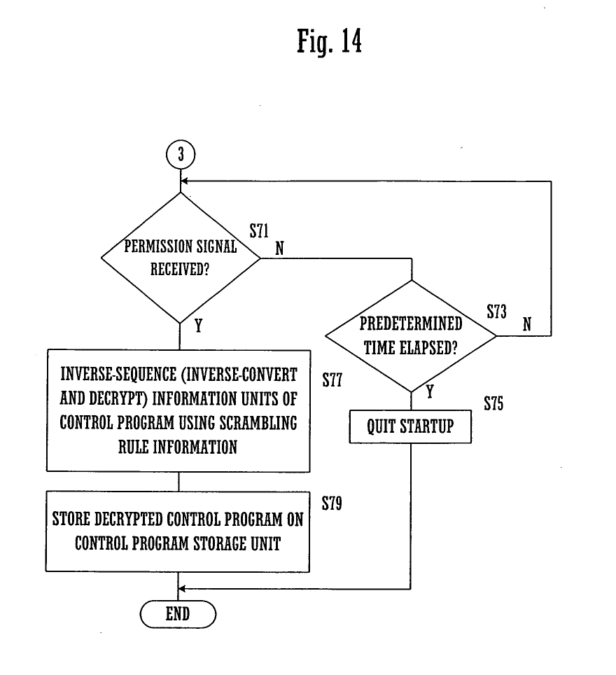

FIGS. 13 and 14 are flowcharts of a startup process executed by the controller 100 in the terminal 1. As illustrated in FIG. 13, the controller 100 determines whether the terminal 1 has been powered on (step S51). If the terminal 1 has been powered on, the startup processor unit 102 reads a startup program from the startup program storage unit 113 and initiates the startup process (step S53).

During the startup process, a transmission request signal is generated and transmitted to the management server 3 (step S55). The controller 100 then determines whether data has been received in response to the transmission request signal (step S57). If no data has been received, the controller 100 waits on standby for data. Alternatively, the transmission request signal is transmitted again or by a predetermined number of times as denoted by a broken line. The received data is a merge signal of the encrypted control program and authentication information discussed with reference to FIGS. 11 and 12.

The received data is temporarily stored on the storage 110 (step S59), and the packets forming the data are converted back to the information units (step S61). The controller 100 then acquires scrambling rule information from the header region of a predetermined packet of the information unit of the received data (step S63).

The controller 100 then separates the control program D and the authentication information E from the merge information (step S65). Using the acquired scrambling rule information, the controller 100 then performs an inverse sequencing process, i.e., inverse conversion (decryption process) on the information units of the separated authentication information (step S67). The decrypted authentication information is transmitted to the management server 3 (step S69).

The controller 100 determines whether a permission signal has been received from the management server 3 (step S71). If no permission signal has been received, the controller 100 repeatedly determines, only within a predetermined period of time equal to time-up, whether a permission signal has been received (no branch from step S73). If no permission signal has been received within the predetermined period of time, the controller 100 quits the startup process (step S75). The controller 100 terminates the process of the main flow.

If a permission signal has been received within the predetermined period of time, the controller 100 then performs an inverse sequencing process, i.e., inverse conversion (decryption process) on the information units of the control program, using the acquired scrambling rule information (step S77). The decrypted control program is then stored on the control program storage unit 114 (step S79). With the control program installed, the control program may be executed subsequent to the startup process.

According to the invention as described above, the terminal 1 separates the authentication information from the merge information of the encrypted control program D and authentication information E, decrypts correctly the authentication information and returns the decrypted authentication information to the management server 3. The management server 3 thus identifies whether the terminal 1 is an appropriate terminal or not by means of checking the decrypted authentication information. The management server 3, on the other hand, performs the encryption process, the generation process of the merge information, and the checking process to see if the authentication information matches the original authentication information, and then transmits the installation permission signal. The terminal 1 thus determines whether the management server 3 is an appropriate server or not by means of checking the installation permission signal. The network system in which the terminal 1 and the management server 3 authenticate each other is thus provided.

The invention also includes the following embodiments.
(1) The embodiment is not limited to information transmission via the dedicated network 6, and is applicable to information transmitted via the Internet 5.
(2) Since a high degree of encryption is implemented by scrambling and then merging the authentication information and the control program in the invention, the merge signal is directly packetized and transmitted. To increase secrecy, a known encryption process may be additionally performed on the packet.

According to the embodiment, the decryption process is performed on the control program after the installation permission signal is received. Alternatively, the control program is decrypted, and is stored (installed) on the control program storage unit 114 in response to the reception of the permission signal.
(4) If the data size of the authentication information is set to be generally constant, and if the number of information units E equals the number of cubes of the virtual geometric structure 70 of a certain size, the size of the virtual geometric structure 70 remains also constant. In these cases, the setting process of the cube size on the authentication information becomes unnecessary. Besides the number of information units E of the authentication information may fail to equal the number of information units D of the control program. Alternatively, depending on the terminal 1, the number of control programs, the type of the control program, and the number of information units may be different. In these cases, there is a possibility that the virtual geometric structures 7 and 70 are different from each other in size. Even in such a case, the rotation axis and the amount of rotation remain the same on the virtual geometric structures 7 and 70 during scrambling. Alternatively, in one embodiment, the scrambling rule may be individually set regardless of whether the virtual geometric structures 7 and 70 have the same size or not.

According to the invention, as described above, a network system transmits via a network a control program stored on a management server to a terminal having transmitted a transmission request of the control program and installs the control program onto the terminal. The management server includes an encryption unit for individually scrambling the control program and authentication information attached to the control program in response to a reception of the transmission request from the terminal, a merging unit for generating merge information by merging the control program and the authentication information subsequent to scrambling, a server-side transmission unit for transmitting the merge information merged by the merging unit to the terminal, and a permission signal generation unit for checking decrypted authentication information returned from the terminal against the original authentication information, and generating a permission signal permitting the control signal to be installed on the terminal and transmitting the permission signal to the terminal if the decrypted authentication information matches the original authentication information. The terminal includes terminal-side transmission unit for transmitting the transmission request to the management server, decryption unit for separating the control program and the authentication information from the merge information received from the management server and decrypting the control information and the authentication information, returning unit for returning the decrypted authentication information to the management server, and installation processor unit for starting installing the control program in response to a reception of the permission signal from the management server.

According to the invention, the management server individually scrambles the control program and the authentication information in response to the transmission request from the terminal. The management server merges the scrambled control program and authentication information, and then transmits the merge information to the terminal. The terminal separates the control program and the authentication information from the merge information, decrypts at least the authentication information, and then returns the decrypted authentication information to the management server. The management server checks the decrypted authentication information against the original authentication information. If the decrypted authentication information matches the original authentication information, the management server generates the permission signal to permit installation, and then transmits the permission signal to the terminal. Upon receiving the permission information, the terminal starts installing (setting up) the control program. The management server at least authenticates an appropriate terminal, identifies a device having a false identity as much as possible, and cuts off connection to the device. Information leak from the management server is thus prevented. The terminal authenticates an appropriate server, identifies an apparatus having a false identity as much as possible, and cuts off connection to the apparatus. The terminal thus prevents information from being leaked from an apparatus having a false identity other than the management server. The terminal further prevents an apparatus having a false identity from inputting an unwanted or an unscrupulous program (software program deleting or transmitting an internal file without permission). Even if the terminal is stolen, important information thereof is free from being stolen.

Preferably, the encryption unit may prepare a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis. The encryption unit may preferably include first and second address conversion unit for rotating the virtual geometric structure successively about each of the central axes in accordance with a predetermined scrambling rule with a pitch of an integer multiple of 1/4(n−1) and calculating a final address responsive to each of the initial addresses subsequent to the shifting, segmentation unit for individually segmenting the predetermined control program and the authentication information into a plurality of information units, and first and second scrambling unit for re-arranging, prior to the transmission, a sequence of the information units of the predetermined control program and a sequence of the information units of the authentication information in accordance with the order of the final addresses, instead of the order of the initial addresses, provided by the first and second address conversion unit. With this arrangement, the address as a scrambling target is scrambled through calculation, and the control program and the authentication information, as transmission targets, are segmented prior to the transmission. The control program and the authentication information are re-arranged in the order as the scrambling results. The control program and the authentication information, as the transmission targets, are encrypted simply and easily.

The first and second address conversion unit may preferably cause the first and second virtual geometric structures to rotate in accordance with the same scrambling rule. With this arrangement, the amount of information of the scrambling rule is reduced.

The first and second address conversion unit may cause the first and second virtual geometric structures to rotate in synchronization with each other. With this arrangement, the address conversion process is performed by one means only. The arithmetic process is reduced in workload, and expedited.

The merging unit may cause the control program to be embedded into the authentication information. With this arrangement, the control program is embedded into the authentication information, and the degree of secrecy of the two pieces of information is even more increased.

Preferably, the authentication information may be binary-coded. Since binary code has no pattern other than a bit unit and “0” and “1,” the authentication information is difficult to learn by analogy. The same authentication information is unlikely to be generated, and a small amount of information works.

The terminal preferably includes uninstall unit for uninstalling the control program in response to a power-off. This arrangement causes the internal control program to be deleted if the terminal is stolen with power off. It is unlikely that information is viewed or stolen.

### INDUSTRIAL APPLICABILITY

According to the invention, of the management server installs the control program on the terminal over the network during the startup of the terminal. To install the control program on the terminal, the control program and the authentication information are encrypted, and merged before being transmitted to the terminal. The terminal decrypts the authentication information appropriately. Upon verifying the authentication information, the management server places the installation permission. The management server can thus identify the terminal as to whether the terminal is an appropriate terminal or a terminal having a false identity.

1. A network system for transmitting via a network a control program stored on a management server to a terminal having transmitted a transmission request of the control program and installing the control program onto the terminal,
wherein the management server comprises:
an encryption unit for individually scrambling the control program and authentication information attached to the control program in response to a reception of the transmission request from the terminal,
a merging unit for generating merge information by merging the control program and the authentication information subsequent to scrambling,
a server-side transmission unit for transmitting the merge information merged by the merging unit to the terminal, and
a permission signal generation unit for checking decrypted authentication information returned from the terminal against a original authentication information, and generating a permission signal permitting the control signal to be installed on the terminal and transmitting the permission signal to the terminal if the decrypted authentication information matches the original authentication information; and
wherein the terminal comprises:
a terminal-side transmission unit for transmitting the transmission request to the management server,
a decryption unit for separating the control program and the authentication information from the merge information received from the management server and individually decrypting the control information and the authentication information,
a returning unit for returning the decrypted authentication information to the management server, and
an installation processor unit for starting installing the control program in response to a reception of the permission signal from the management server.

2. The network system according to claim 1, wherein the encryption unit prepares a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis, and
wherein the encryption unit comprises:
first and second address conversion units for rotating the virtual geometric structure successively about each of the central axes in accordance with a predetermined scrambling rule with a pitch of an integer multiple of 1/4(n−1) and calculating a final address responsive to each of the initial addresses subsequent to the shifting,
a segmentation unit for individually segmenting the predetermined control program and the authentication information into a plurality of information units, and
first and second scrambling units for re-arranging, prior to the transmission, a sequence of the information units of the predetermined control program and a sequence of the information units of the authentication information in accordance with the order of the final addresses, instead of the initial addresses, provided by the first and second address conversion units.

3. The network system according to claim 2, wherein the first and second address conversion units cause the first and second virtual geometric structures to rotate in accordance with the same scrambling rule.

4. The network system according to claim 3, wherein the first and second address conversion unit cause the first and second virtual geometric structures to rotate in synchronization with each other.

5. The network system according to claim 1, wherein the merging unit causes the control program to be embedded into the authentication information.

6. The network system according to claim 1, wherein the authentication information is binary-coded.

7. The network system according to claim 1, wherein the terminal comprises an uninstall unit for uninstalling the control program in response to a power-off.

8. An authentication method of a network system for transmitting via a network a control program stored on a management server to a terminal having transmitted a transmission request of the control program and installing the control program onto the terminal, comprising:
a step of terminal-side transmission of the terminal for transmitting the transmission request to the management server,
a step of encryption of the management server for individually scrambling the control program and authentication information attached to the control program in response to a reception of the transmission request from the terminal,
a step of merging of the management server for generating merge information by merging the control program and the authentication information subsequent to the scrambling,
a step of server-side transmission of the management server for transmitting the merge information merged by the step of merging to the terminal,
a step of decryption of the terminal for separating the control program and the authentication information from the merge information received from the management server and individually decrypting the control information and the authentication information,
a step of returning of the terminal for returning the decrypted authentication information to the management server,
a step of permission signal generation of the management server for checking the decrypted authentication information returned from the terminal against the original authentication information, and generating a permission signal permitting the control signal to be installed on the terminal and transmitting the permission signal to the terminal if the decrypted authentication information matches the original authentication information, and
a step of installation processor of the terminal for starting installing the control program in response to a reception of the permission signal from the management server.
